(19) United States
(12) Patent Application Publication
(10) Pub. No.: US 2001/0046268 A1
(43) Pub. Date: Nov. 29, 2001

(54) Transceiver channel bank with reduced connector density

(76) Inventor: Alok Sharma, San Jose, CA (US)

Correspondence Address: WALSTEIN BENNETT SMITH III, P. O. BOX 1668, GEORGETOWN, TX, 78628, US

(21) Appl. No.: 09/798,437

(22) Filed: Mar. 2, 2001

Related U.S. Application Data
(60) Provisional application No. 60/187,194, filed on Mar. 6, 2000.

(51) Int. Cl. H04L 27/14

(52) U.S. Cl. 375/324

(57) ABSTRACT

The channel bank architecture of the present invention reduces connector density, reduces costs and other bulk components, and improves the system noise performance. The connector density is reduced through an architecture that digitizes the entire upstream spectrum and buses the digitized result to the input of multiple digital receivers. The digital receivers have all digital hardware-based filters and demodulators. Stored prototype D.C. coefficients are bandpass transformed, enabling the receivers to be programmed to essentially any arbitrary center frequency over a wide-range of bandwidths, and provide great frequency agility. Reprovisioning is possible by sending commands to the line card. The number of receiver inputs, associated connectors, and associated splitter taps is reduced by a factor of 1/M. In an illustrative embodiment, M is 16. Taking into account the total number of connectors for both upstream and downstream connectors, the connector count is reduced by a factor 1/T, where T is a function of the D/U ratio and M. In an illustrative embodiment T is 4. In an illustrative 4D×16U CMTS channel bank embodiment, having 4 downstream channels and 16 upstream channels, four connectors are required for the downstream channels and only a single connector is required for all 16 upstream channels. The illustrative embodiment thus has 5 total connectors, compared to 20 total connectors in a comparable prior art system.

### BACKGROUND

Digital receivers digitize a complex signal (i.e., a signal having multiple frequency components) using an Analog-to-Digital Converter (ADC) and perform signal decomposition or demodulation solely by manipulation of the digitized samples (i.e., via Digital Signal Processing, or DSP). Digital receiver techniques in general, and wideband digital receiver techniques in particular, are taught in “Digital Techniques for Wideband Receivers,” by James Tsui, Artech House Publishers, 1995, ISBN 0-89006-808-9. In particular, see Chapter 6, “Analog-to-Digital Converters;” Chapter 7, “Amplifier and Analog-to-Digital Converter Interface;” and Chapter 11, “Frequency Channelization.” Digital receiver techniques are also taught in Chapter 7, “Digital Receivers: implementation and Design,” of “Cellular Radio & Personal Communications, Volume 2,” editied by T.S. Rappaport, IEEE, 1996, ISBN 0-7803-2307-6.

The Tsui reference focuses on (although its teachings are not limited to) receivers employing an Intermediate Frequency (IF) conversion stage prior to the ADC and on the use of Discrete Fourier Transform (DFT) techniques embodied in programs executed on high-speed processors. It is prophetic with respect to advances in direct digitization of Radio-Frequency (RF) signals in the receiver front-end, where only RF amplifiers and bandpass filters precede the ADC.

DSP methods have also been used to create digital “filter banks.” Conceptually, there are “analysis filter banks” and “synthesis filter banks,” depending respectively on whether signal decomposition or signal synthesis is being performed. An analysis filter bank decomposes a relatively wide-bandwidth complex signal (i.e., a signal generally having multiple frequency or carrier components) into multiple respective relatively narrow-bandwidth sub-bands (generally having a single frequency or carrier component). Conversely, a synthesis filter bank combines relatively narrow-bandwidth sub-bands (generally having a single frequency component) to create a relatively wide-bandwidth complex signal (generally having multiple frequency components). Both the analysis and synthesis filters operate entirely in the digital domain, unless indicated otherwise. However, often the wide-bandwidth complex signal has been converted from (for analysis filters), or is to be converted to (for synthesis filters), an analog-domain equivalent.

Often the digital filter banks use Fast Fourier Transform (FFT) (or Fast Cosine Transform, FCT) methods implemented as a processor executed program. In the most common applications, these FFT or FCT-based filter banks have multiple virtual filter bins (spectral analysis output variables) corresponding to respective bandpass regions that are uniform, frequently have overlapping frequency coverage, generally have small bandwidth (30 kHz and less), and have center frequencies ranging up to the low-tens of MHz. Signals of interest at higher center frequencies are generally preprocessed using IF downconversion techniques.

In some applications only one type of filter bank (analysis or synthesis) is used. The broadest use of analysis filter banks has been to implement parallel AM demodulation for spectral analysis or frequency demultiplexing. Conversely, synthesis filter banks can be used to synthesize a complex signal or for frequency multiplexing.

In other applications, analysis and synthesis banks are coupled together. In communication and networking applications, multiple relatively narrow-bandwidth digital-domain sub-bands exist at remote end-points, while a relatively wide-bandwidth complex signal is sent on the (often analog, frequency multiplexed) communications media (circuit) coupling the remote end-points. Thus, each transmit side uses a synthesis filter-bank (followed by a Digital-to-Analog Converter, DAC, for an analog circuit) and each receive side uses an analysis filter bank (preceded by an ADC for an analog circuit). This digital filter bank architecture is used with Discrete Multitone Transmission (DMT) and with transmultiplexers (used in TDM-to-FDM channel-to-TDM), both used in conjunction with analog, frequency multiplexed circuits.

Conversely, in signal conditioning, modulation, and demodulation functions, relatively wide-bandwidth complex signals exist at the input and outputs of the function block, wherein relatively narrow-bandwidth sub-band signals exist internal to the function block. Thus, the input side uses an analysis filter-bank and the output side uses a synthesis filter-banks This digital filter bank architecture is used for compression and signal enhancement algorithms, particularly with respect to speech coding applications.

Multirate signal processing refers to DSP techniques that make use of multiple sampling rates. Multirate signal processing techniques include interpolation and decimation processes. Interpolation (oversampling) increases the sampling rate and acts to create multiple replicas of a sampled signal spectrum and has particular application to passband upconversion. Decimation (undersampling, or downsampling) decreases the sampling rate and acts to alias the sampled signal spectrum and has particular application to passband downconversion.

Multirate signal processing has particular application to both analysis and synthesis filter banks. Analysis filter banks may use decimation methods for passband downconversion and to reduce sampling rates for the output sub-bands, compared to the complex signal being decomposed. Conversely, synthesis filter banks may use interpolation methods for passband upeonversion required to create complex signals with higher frequency content than exist in the component sub-bands.

A comprehensive teaching of generic DSP techniques is found in “Digital Signal Processing: Principles, Algorithms, and Applications,” by J. G. Proakis and D. G. Manolakis, Prentice-Hall, 1996, ISBN 0-13-373762-4. In particular, see Chapter 8, “Design of Digital Filters;” Chapter 9, “Sampling and Reconstruction of Signals;” and Chapter 10, “Multirate Digital Signal Processing.”

DSP techniques with particular application to telecommunications are taught in “Digital Signal Processing in Telecommunications,” by Kishan Shenoi, Prentice-Hall, 1995, ISBN 0-13-096751-3. In particular, see Chapter 7, “Bandpass Filters, Transmultiplexers, and the Discrete Fourier Transform (DFT);” and Chapter 9, “Design of Recursive (IIR) Digital Filters.”

General techniques for RF circuits and systems, including digital modulation and demodulation schemes, are taught in “RF Microelectronics,” by Behzad Ravavi, Prentice-Hall, 1998, ISBN 0-13-887571-5. In particular, see Chapter 2, “Basic Concepts in RF Design;” Chapter 3, “Modulation and Detection;” and Chapter 5, “Transceiver Architectures.”

Cable Television and Related Advanced 2-way cable services, including internet connectivity, are taught in “Modern Cable Television Technology: Video, Voice, and Data Communications;” by W. Ciciora, J. Farmer, and D. Large; Morgan Kaufmann Publishers; 1999; ISBN 1-55860-416-2. RF Interface Standards for Data-Over-Cable systems are taught in the Data-Over-Cable Service Interface Specifications (DOCSIS): Radio Frequency Interface Specification: SP-RFIv1.1-IO3-991105; published and distributed by Cable Television Laboratories, Inc.; 1999.

In prior art channel bank systems, every upstream channel requires a respective splitter tap, receiver input including a bulkhead-mount connector, and cabling between the splitter tap and the receiver input. Such components add cost and bulk that would otherwise not be expended. Miniaturization of the line cards and the channel bank as a whole, are limited by these required components and are particularly limited by the connector density.

The prior art channel banks have limited choices for center frequency and bandwidth. Requirements for all channels to be of uniform bandwidth have limited the available provisioning configurations. Additionally, prior art channel banks have required manual adjustments or manual changing of plug-in components, in order to provision or reprovision channel.

What is needed is a receiver channel bank architecture that permits miniaturization of line cards and channel banks by reducing the number of connectors required What is further needed is a method to enable the receivers to be programmed to essentially any arbitrary center frequency, permits selection over a wide-range of bandwidths, and provides great frequency agility. What is farther needed is the ability to reprovision the receiver channel bank without manual intervention.

### BRIEF DESCRIPTION OF DRAWINGS

FIG. 1 shows a prior art cable system using a typical tree-and-branch topology.

FIG. 2 shows a prior art cable system using hybrid fiber-coax.

FIG. 3A and FIG. 3B are a spectrum diagram and a spectrum table, for an illustrative frequency use plan.

FIG. 4 is a high-level abstraction of a prior art Data-Over-Cable system.

FIGS. 5A through 5C comprise a more detailed abstraction of the prior art system in FIG. 4.

FIG. 6 provides additional detail of the data receiver interface for the Cable Modem Termination System (CMTS) of FIGS. 5A through 5C.

FIG. 7 is an abstraction for the Block Segment Converter (Frequency Stacker) of FIG. 6.

FIG. 8 provides details of a data receiver interface for a CMTS, in accordance with the present invention.

FIG. 9 shows the internal architecture of an illustrative embodiment of a 4D×16U module used in a CMTS line card, in accordance with the present invention.

FIG. 10 shows details of the receiver block 250 used multiple times in the receiver bank 200 of FIG. 9.

FIG. 11 shows a prior art FIR digital filter that is used in an illustrative embodiment for the digital filter block of FIG. 10.

FIG. 12 shows the bandwidths and accompanying symbol and bit rates that may be obtained through the programmable provisioning of the digital filter block of FIG. 10.

FIG. 13 is a flow chart describing the (re)provisioning of the digital filter block within selected one of the receivers of FIG. 9.

FIG. 14 shows an illustrative embodiment of 4D×16U module 100 of FIG. 9, wherein four transmitter sub-modules 300 and one receiver sub-module 200 are implemented on a single integrated circuit.

FIG. 15 shows another illustrative embodiment of the 4D×16U module 100 of FIG. 9, wherein 4 transmitter sub-modules 300, one receiver sub-module 200, the ADC 500, and the non-volatile storage for the D.C. Coefficients 710, are implemented on a single integrated circuit.

FIG. 16 shows a line card for a CMTS using multiple instances of the 4D×16U module 100 of FIG. 9.

FIG. 17A shows the connector density of the prior art for a 32D×128U CMTS channel bank. FIG. 17B shows the connector density of an illustrative embodiment in accordance with the present invention for a 32D×128U CMTS channel bank. FIG. 17C is the legend for the connector symbols used in FIG. 17A and FIG. 17B.

FIG. 18 compares the line card connector count for CMTS channel banks for both the prior art and in accordance with the present invention.

FIG. 19A shows an illustrative embodiment of the present invention as applied to receiving upstream channels in the 750-1000 MHz portion of the spectrum plan illustrated by FIG. 3A and FIG. 3B. FIG. 19B details the bandpass characteristics for each sub-band Analog pre-filter used in FIG. 19A.

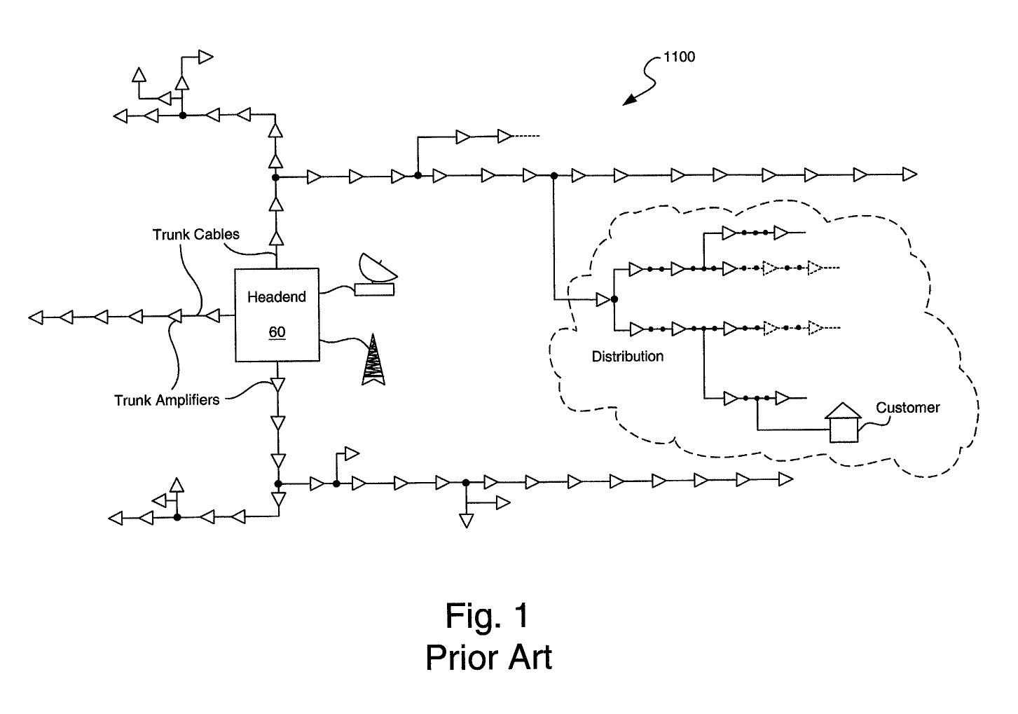

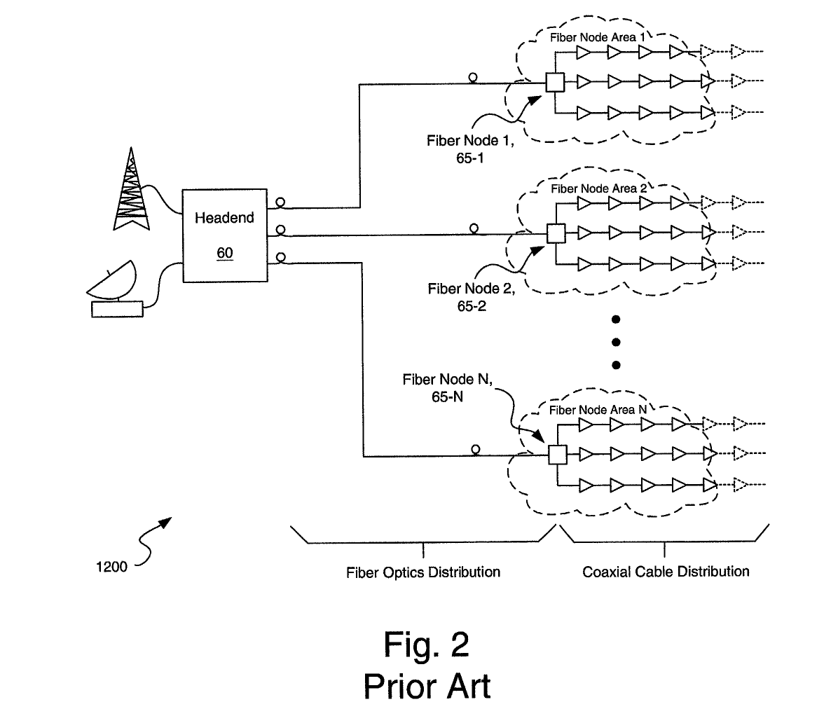

### SUMMARY

The channel bank architecture of the present invention reduces connector density, reduces costs and other bulk components, and improves the system noise performance. The number of receiver inputs, associated connectors, and associated splitter taps is reduced by a factor of 1/M, where M is roughly the number of channels acceptable performance and cost criteria for the system. M is largely a function of the performance of an ADC chosen, but in certain applications in where the aggregate bandwidth is relatively modest, and thereby ADC selection is not a major cost factor, M may be chosen based on the total upstream bandwidth divided by an educated estimate for what will be the practical worst-case combined channel bandwidth. In an illustrative embodiment, M is 16. That is, the receiver connector count for channel banks in accordance with the present invention is one-sixteenth that of prior art systems.

In an illustrative embodiment, the ratio of downstream (D) to upstream (U) channels implemented in a CMTS channel bank is 1:4. Taking into account the total number of connectors for both upstream and downstream connectors, the connector count is reduced by a factor 1/T, where T is a function of the D/U ratio and M. In an illustrative embodiment T is 4. That is, the total connector count for channel banks in accordance with the present invention is one-fourth that of prior art systems. In an illustrative 4D×16U embodiment, having 4 downstream channels and 16 upstream channels, four connectors are required for the downstream channels and only a single connector is required for all 16 upstream channels. The illustrative embodiment thus has 5 total connectors, compared to 20 total connectors in a comparable prior art system.

The connector density is reduced through an architecture that digitizes the entire upstream spectrum and buses the digitized result to the input of multiple digital receivers. The digital receivers have all-digital hardware-based filters and demodulators. The output of the receivers is a bit-stream corresponding to the particular upstream channel for which the receiver is provisioned.

The present invention maintains pre-computed sets of D.C. filter coefficients in non-volatile storage, each set corresponding to one of multiple prototype low-pass digital filters, each filter having one of a predetermined set of bandwidths. When a desired center frequency and bandpass bandwidth are selected for provisioning a particular receiver, the D.C. coefficients associated with the desired bandwidth are retrieved and subjected to a band-pass transformation. The resulting operational coefficients are then loaded into coefficient latches in the digital filter for a selected receiver from the channel bank.

The storage of prototype D.C. coefficients that are subsequently bandpass transformed, enables the receivers to be programmed to essentially any arbitrary center frequency, permits selection over a wide-range of bandwidths, and provides great frequency agility. Reprovisioning is possible by sending commands to the line card. No manual adjustments or manual changing of plug-in components is required.

### DETAILED DESCRIPTION

Frequency Stacking

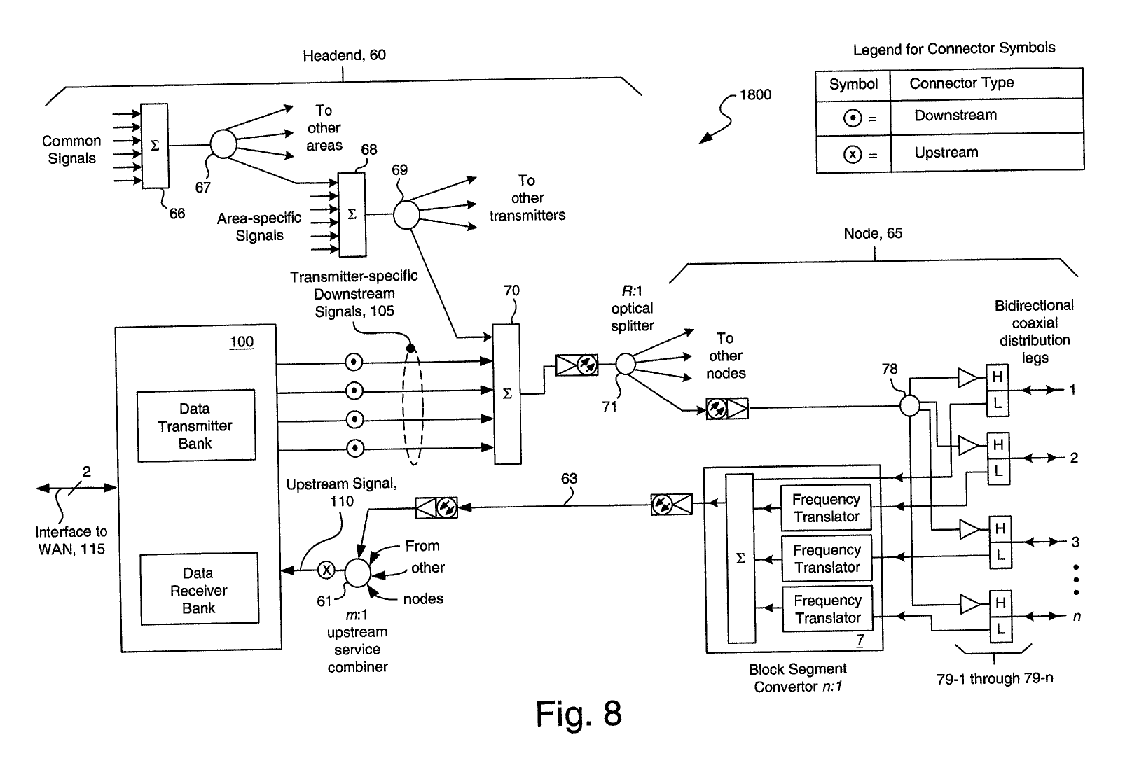

FIG. 8 provides details of a data receiver interface for a CMTS, in accordance with the present invention. The Block Segment Converter, or Frequency Stacker, permits optimal use of the invention, by enabling presentation of a contiguous upstream spectrum to the data receiver banks. The stacker efficiently organizes otherwise unrelated multiple channels into a densely packed spectrum on a single cable, which can be subsequently coupled to the ADC via an associated single connector.

internal Architecture

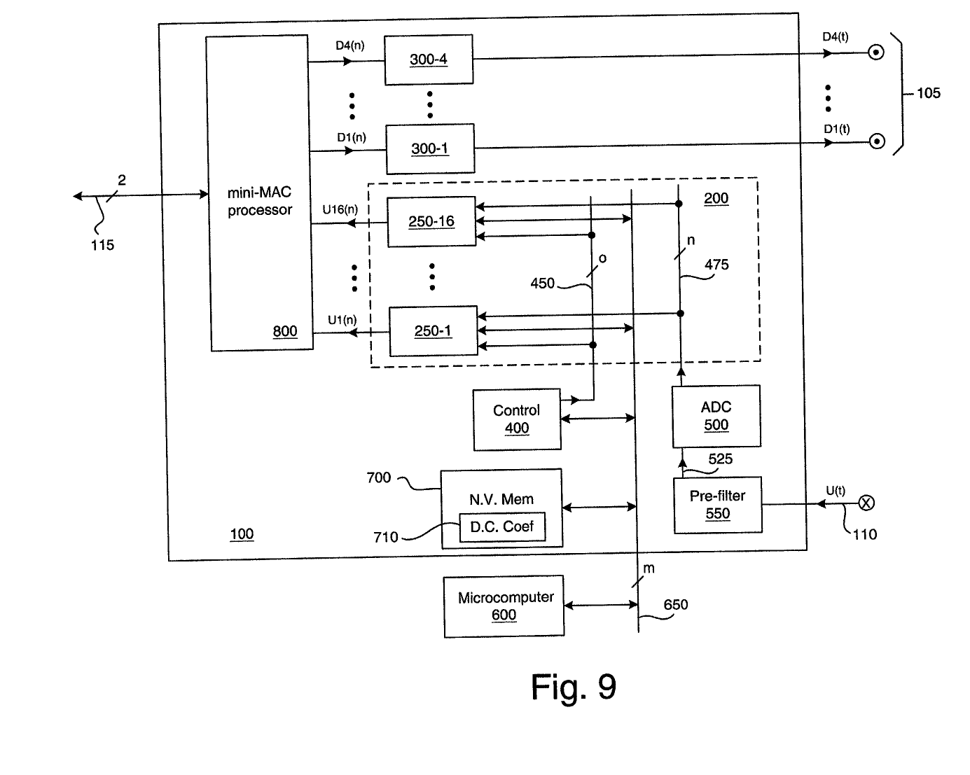

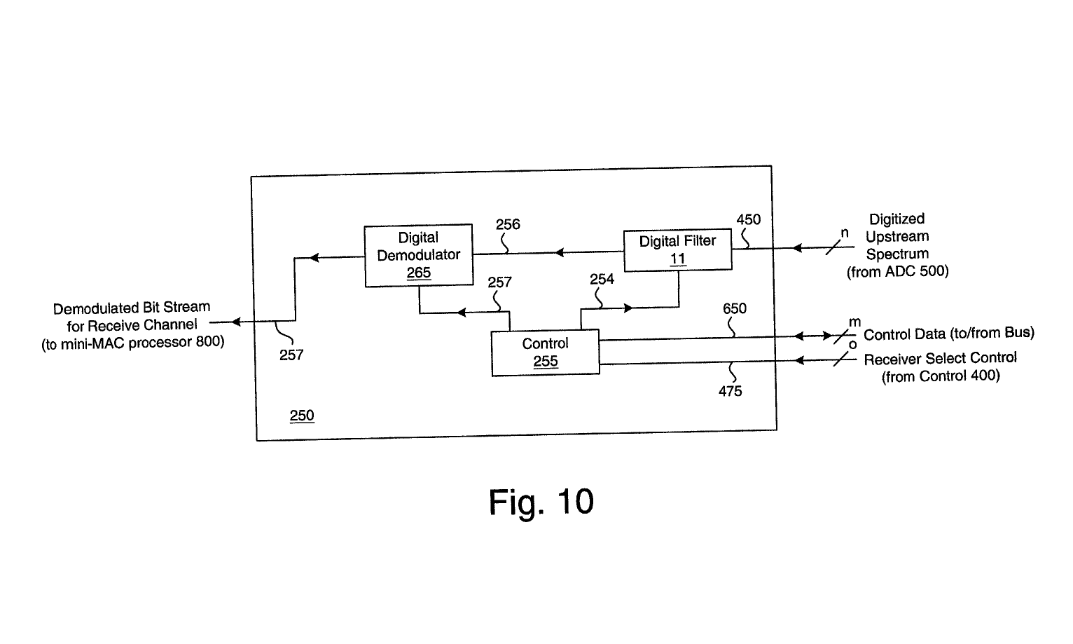

FIG. 9 shows the internal architecture of a 4D×16U module used in a CMTS line card, in accordance with the present invention. FIG. 10 shows details of the receiver block 250 used multiple times in the receiver bank 200 of FIG. 9.

Computation of Digital Filter DC Coefficients

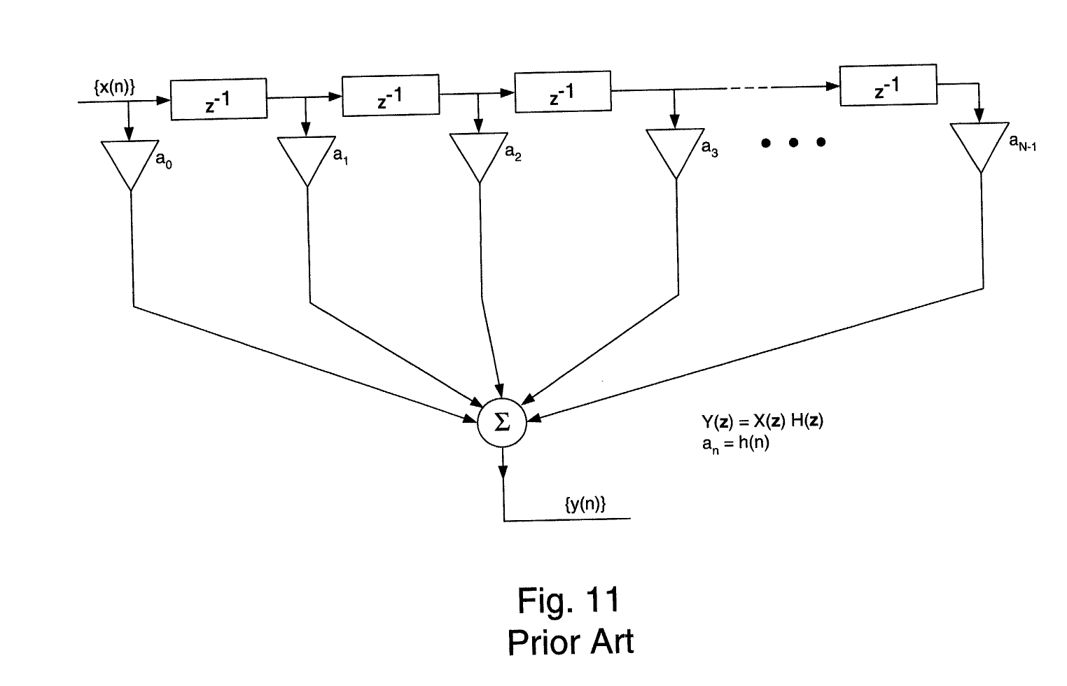

FIG. 11 shows a prior art FIR digital filter that is used in an illustrative embodiment for the digital filter block of FIG. 10. The digital filter chosen is an Optimum Equiripple Linear-Phase FIR Filter. A Chebyshev approximation is used, wherein the weighted approximation error between the desired frequency response and the actual frequency response is spread evenly across the passband and evenly across the stopband of the filter minimizing the maximum error. The resulting filter designs have ripples in both the passband and the stopband. The specific approximation used is the Parks-McClellan Alternation theorem.

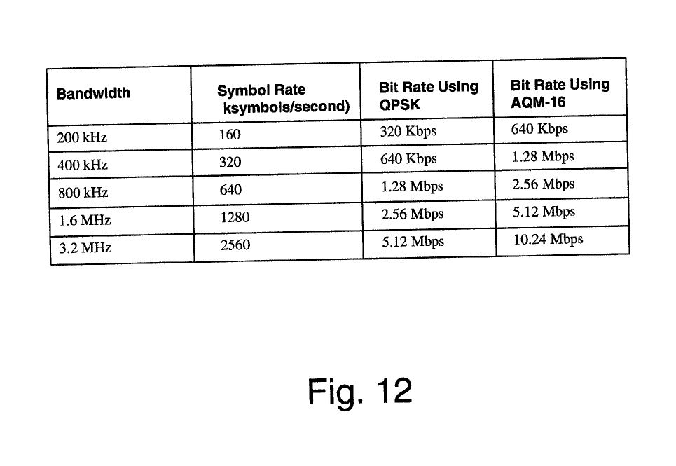

Prototype lowpass filters are designed for each desired bandwidth. FIG. 12 shows the bandwidths and accompanying symbol and bit rates that may be obtained through the programmable provisioning of the digital filter block of FIG. 10. The coefficients for a DC center frequency are computed for each desired bandwidth using a Parks-McClellan program employing the Remez exchange algorithm (or the Rabiner variation), as decribed in section 8.2.4 of the Proakis and Manolakis text. The Parks-McClellan program is executed or interpreted using any numerical analysis application suite, including preferred applications such as MATLAB or Mathmatica.

Tradeoffs must be made between passband ripple (less is better), stopband attenuation (more is better), for a fixed number of coefficients (proportional to area costs for filter stages and coefficient storage). Improvements may be realized in both passband ripple and stopband attenuation with additional coefficients. In preferred embodiments, the number of coefficients is between 16 and 24.

Dynamic Configuration for Arbitrary Center Frequency and Bandwidth

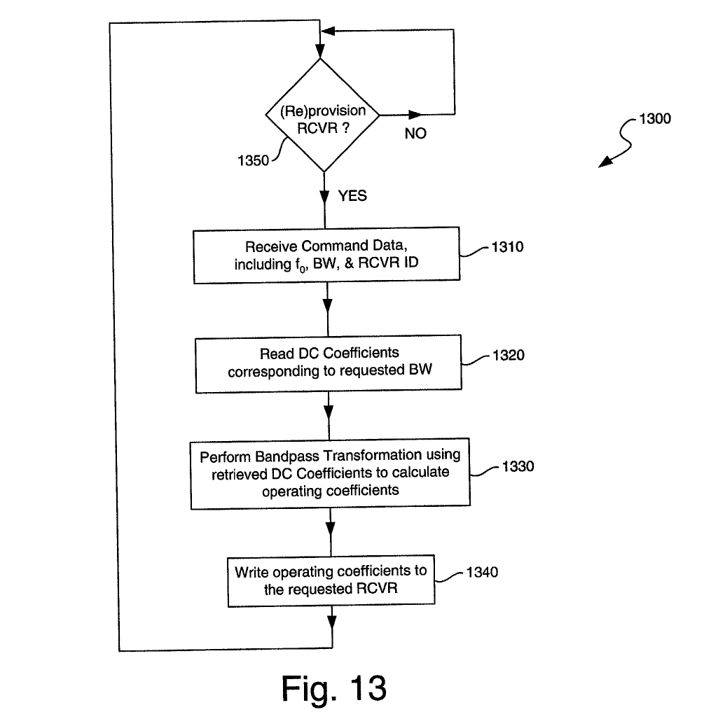

FIG. 13 is a flow chart describing the (re)provisioning of the digital filter block within a selected one of the receivers of FIG. 9. The operational coefficients are generated in the field during provisioning from the corresponding DC coefficients. The DC coefficients for the prototype lowpass filter, corresponding to the desired bandpass bandwidth, are retrieved from the non-volatile storage and are used to generate the operational coefficients in the field during provisioning. This field generation is done using the Bandpass Transformation described in section 8.4.2 of Proakis and Manolakis.

Dynamic Channel Assignment

When a desired center frequency and bandpass bandwidth are selected for provisioning a particular receiver, the D.C. coefficients associated with the desired bandwidth are retrieved and subjected to a band-pass transformation. The resulting operational coefficients are then loaded into coefficient latches in the digital filter for a selected receiver from the channel bank.

Frequency Agile Operation

The storage of prototype D.C. coefficients that are subsequently bandpass transformed, enables the receivers to be programmed to essentially any arbitrary center frequency, permits selection over a wide-range of bandwidths, and provides great frequency agility. Reprovisioning is possible by sending commands to the line card. No manual adjustments or manual changing of plug-in components is required.

Reduction in Connectors

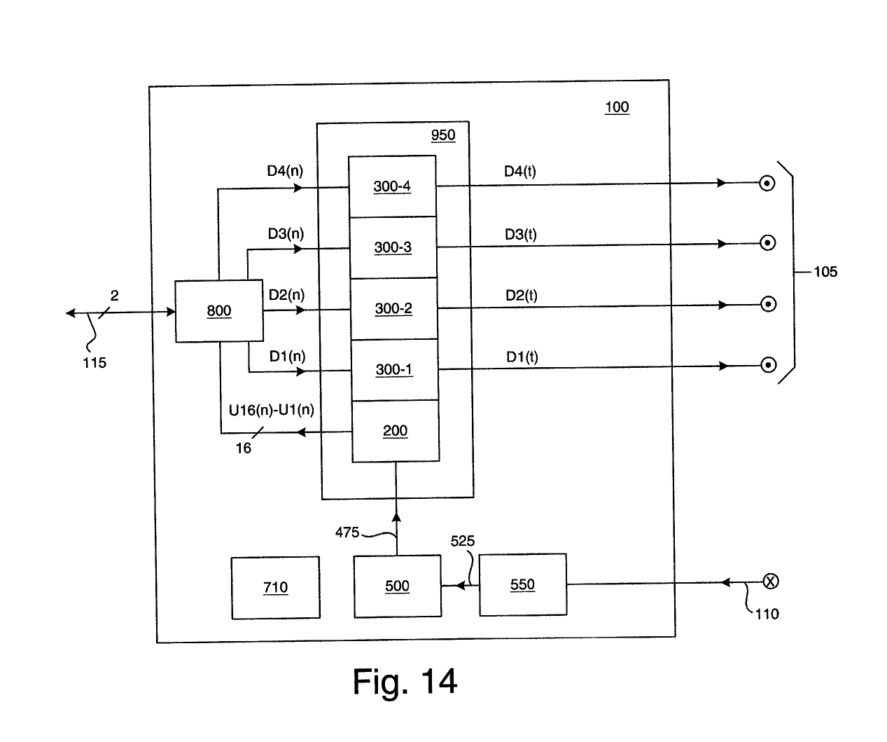

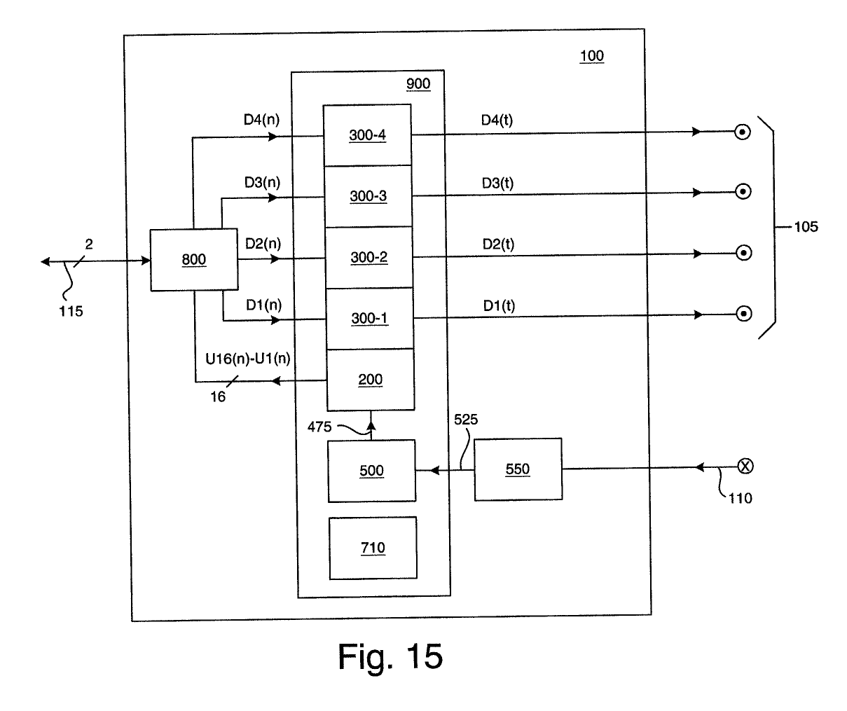

FIG. 14 shows an illustrative embodiment of 4D×16U module 100 of FIG. 9, wherein four transmitter sub-modules 300 and one receiver sub-module 200 are implemented on a single integrated circuit. In this illustrative 4D×16U embodiment, there are 4 downstream channels and 16 upstream channels. Four connectors are required for the downstream channels and only a single connector is required for all 16 upstream channels. The illustrative embodiment thus has 5 total connectors, compared to 20 total connectors in a comparable prior art system.

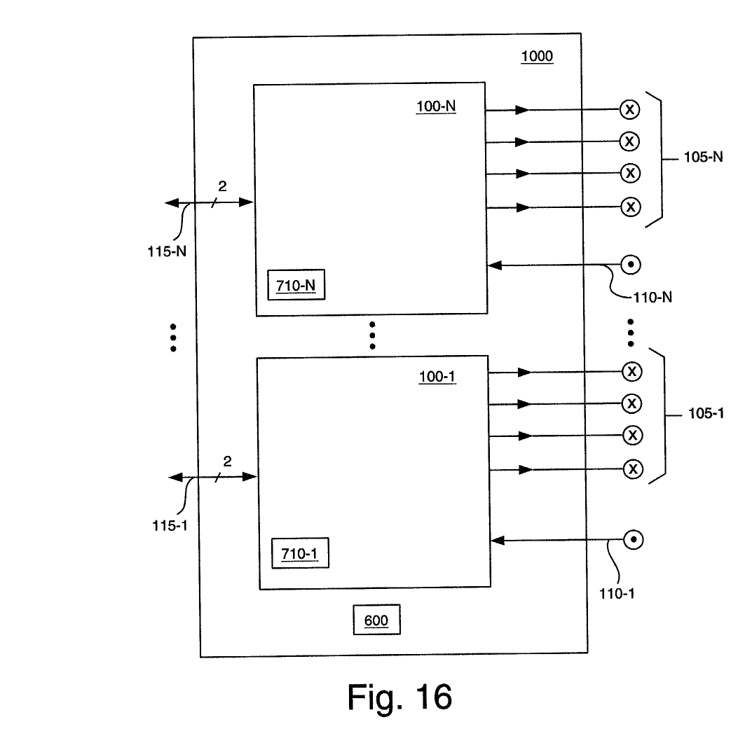

FIG. 15 shows another illustrative embodiment of the 4D×16U module 100 of FIG. 9, wherein 4 transmitter sub-modules 300, one receiver sub-module 200, the ADC 500, and the non-volatile storage for the D.C. Coefficients 710, are implemented on a single integrated circuit. FIG. 16 shows a line card for a CMTS using multiple instances of the 4D×16U module 100 of FIG. 9.

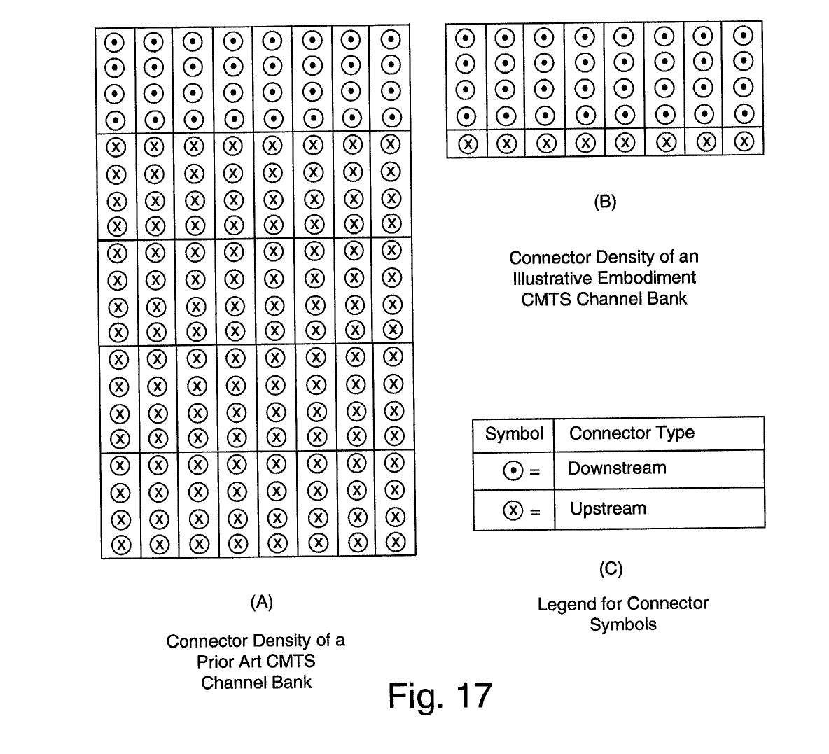

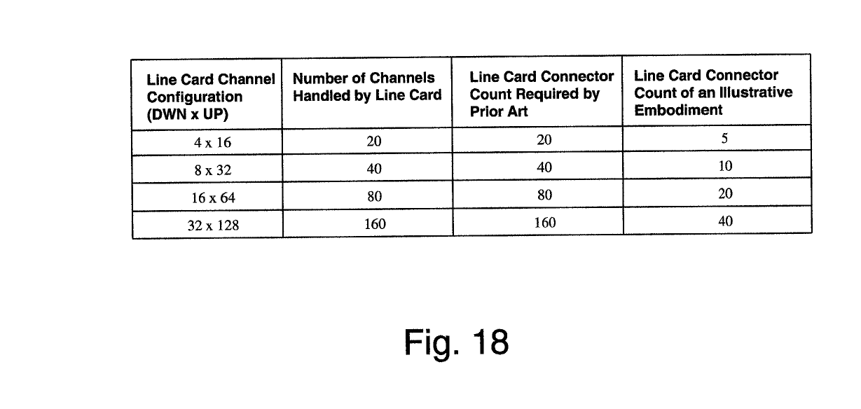

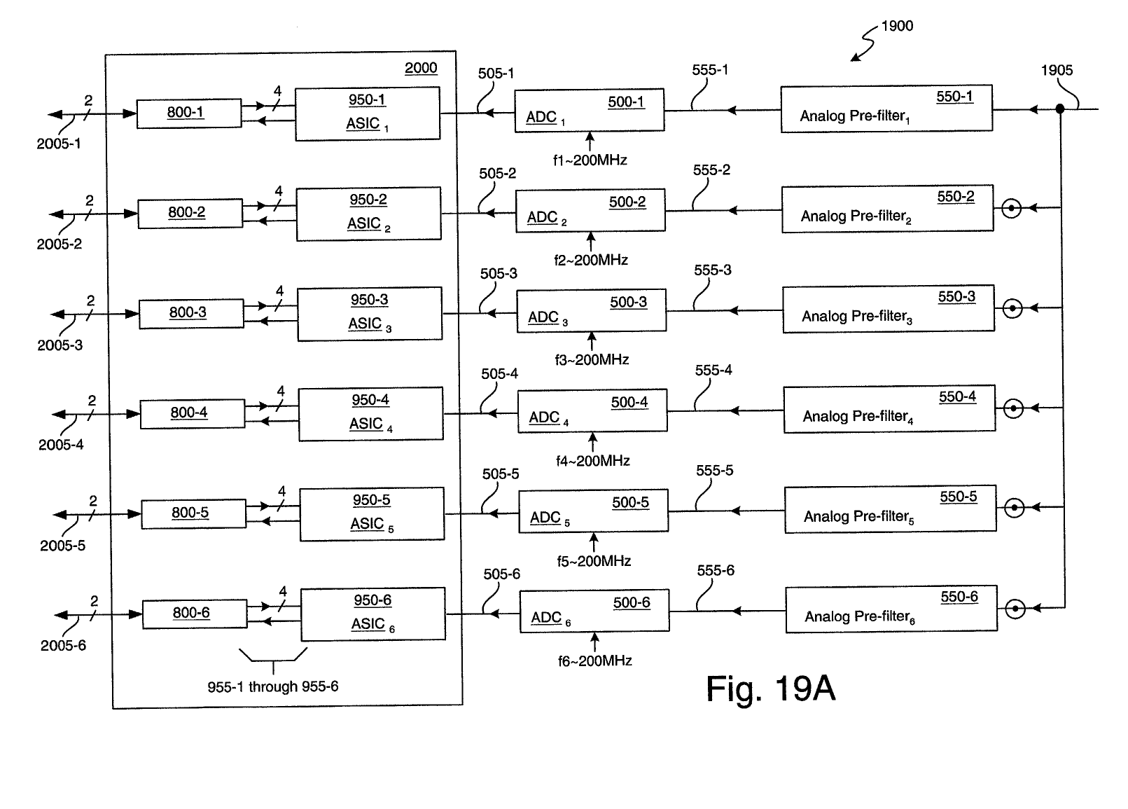

FIG. 17A shows the connector density of the prior art for a 32D×128U CMTS channel bank. FIG. 17B shows the connector density of an illustrative embodiment in accordance with the present invention for a 32D×128U CMTS channel bank. FIG. 17C is the legend for the connector symbols used in FIG. 17A and FIG. 17B. FIG. 18 compares the line card connector count for CMTS channel banks for both the prior art and in accordance with the present invention.

As previously indicated the number of receiver inputs, associated connectors, and associated splitter taps is reduced by the factor of 1/M, while the total number of both upstream and downstream connectors is reduced by the factor 1/T. In the illustrative embodiment shown, M is 16, and T is 4. That is, the receiver connector count for channel banks in accordance with the present invention is one-sixteenth that of prior art systems, and the total connector count for channel banks in accordance with the present invention is one-fourth that of prior art systems.

Non-baseband Channel Groups

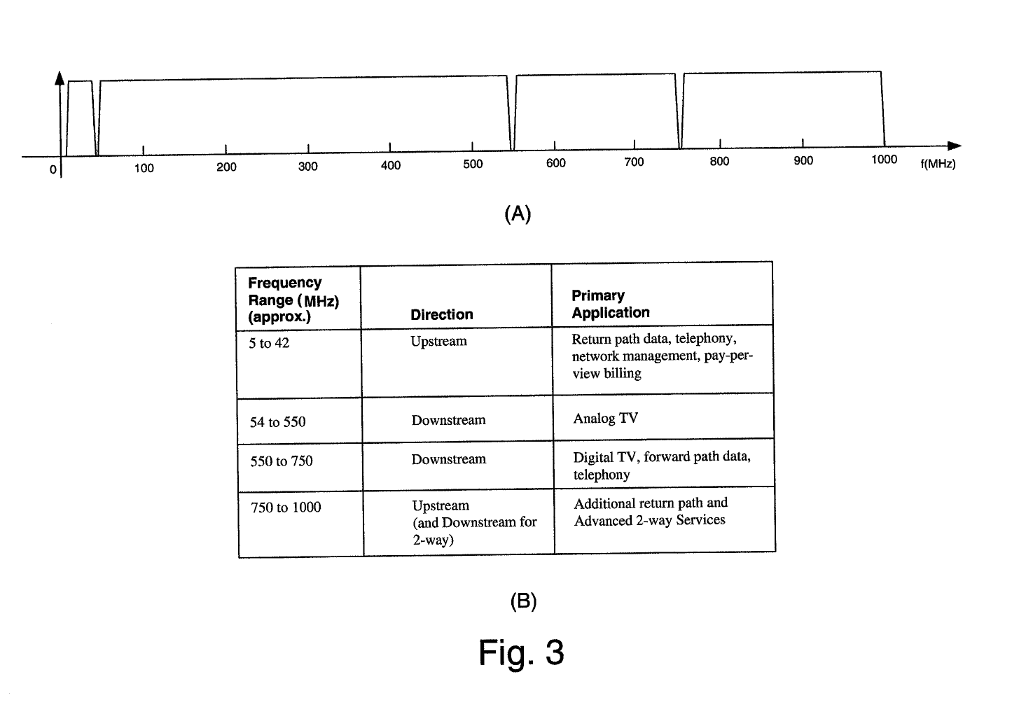

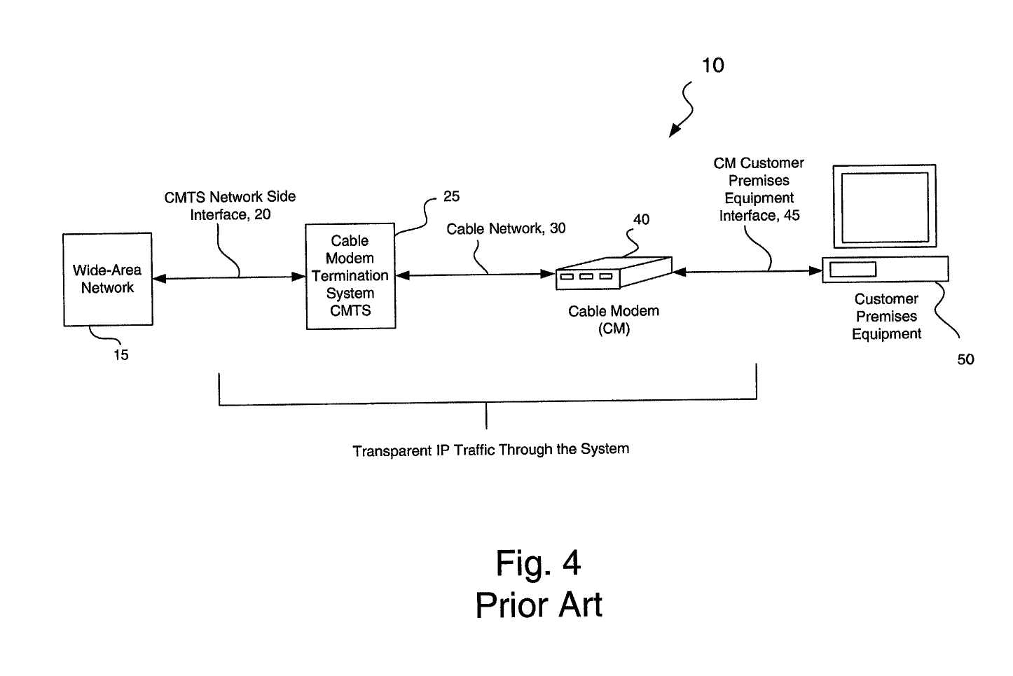

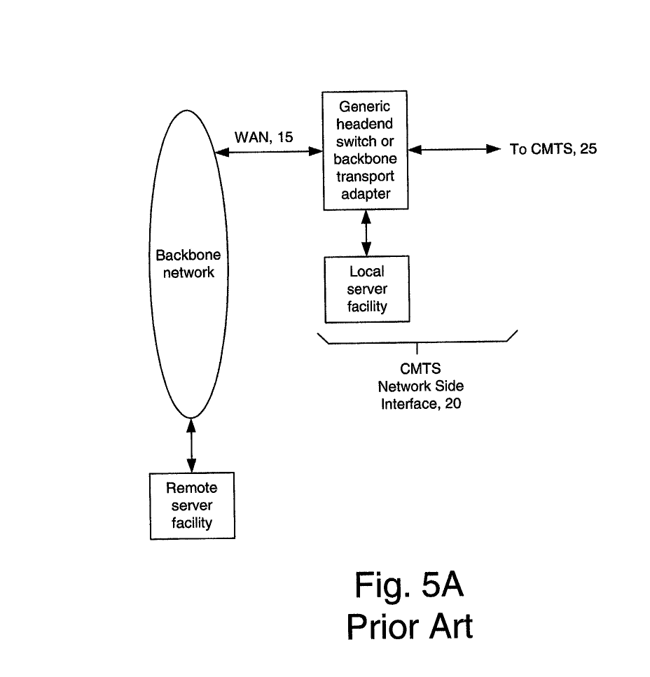

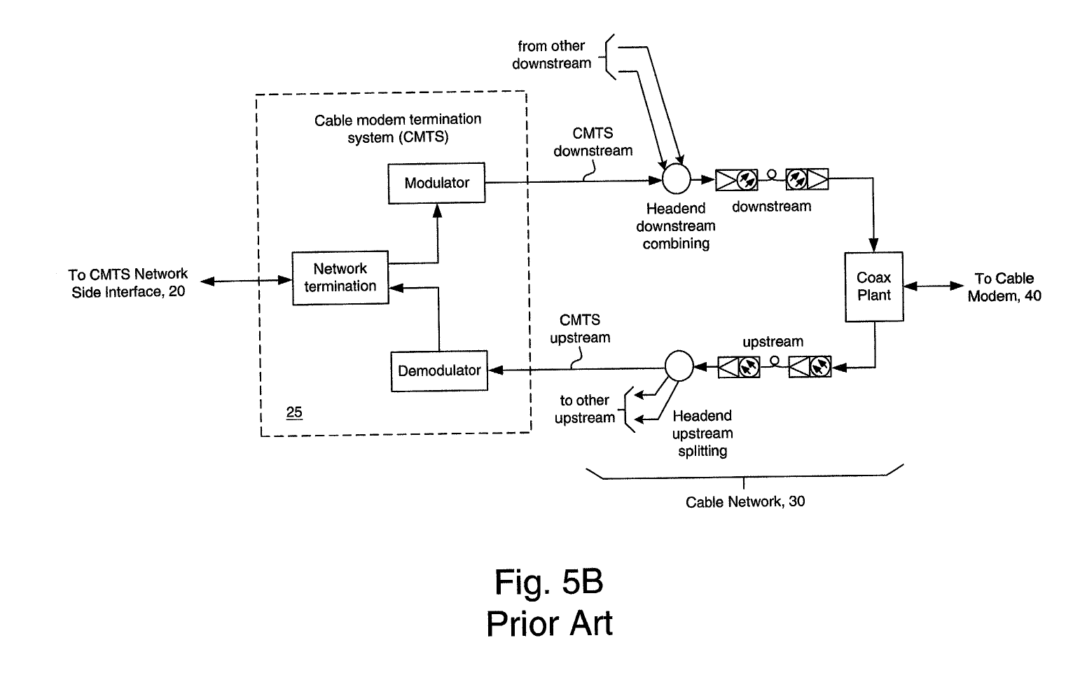

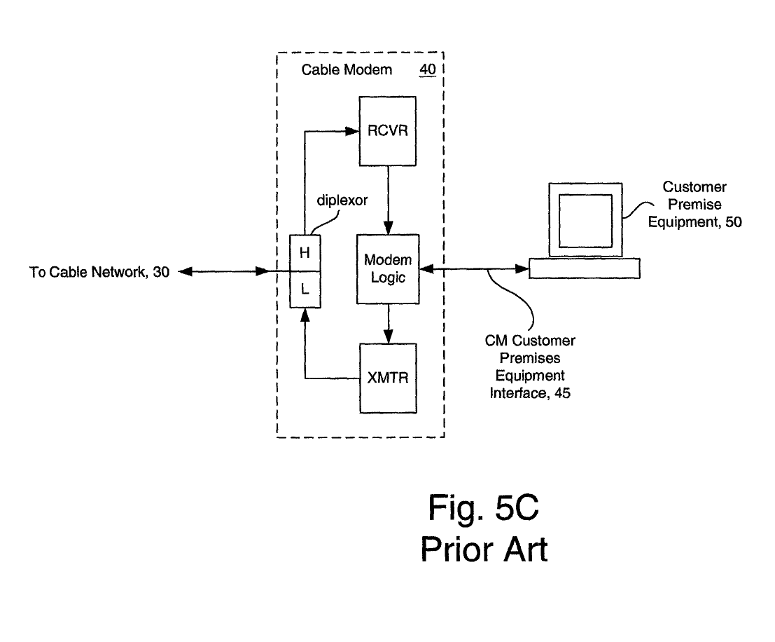

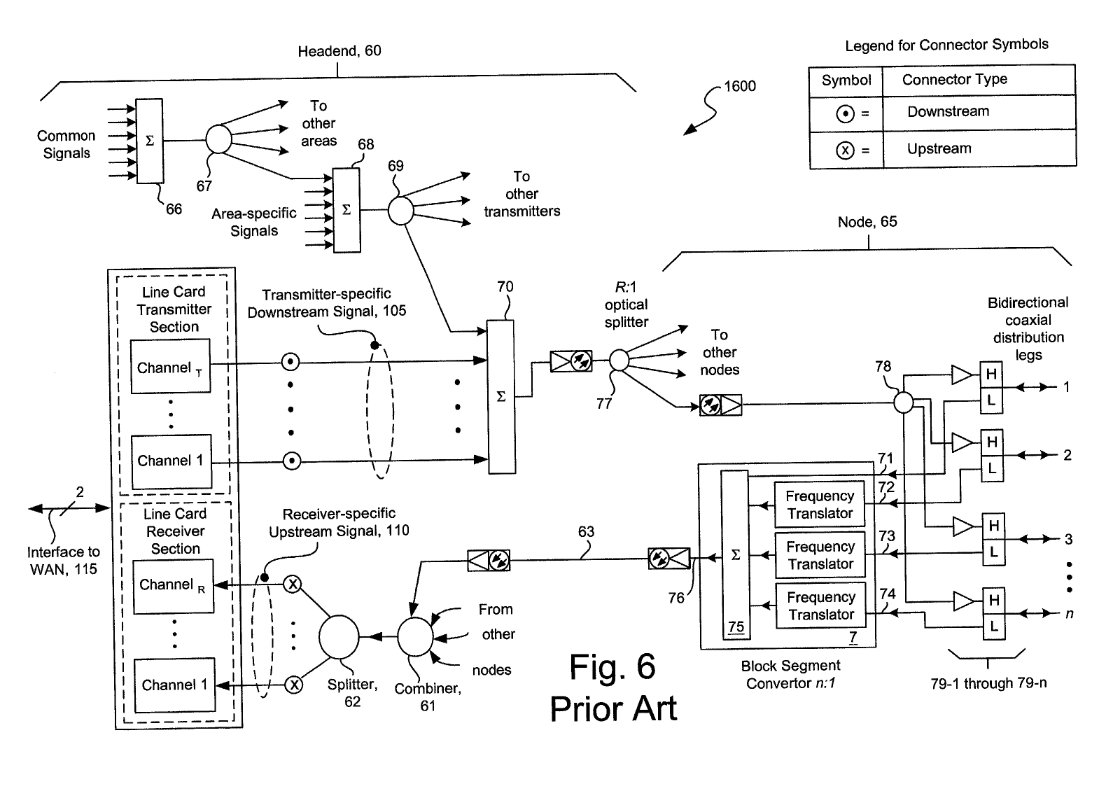

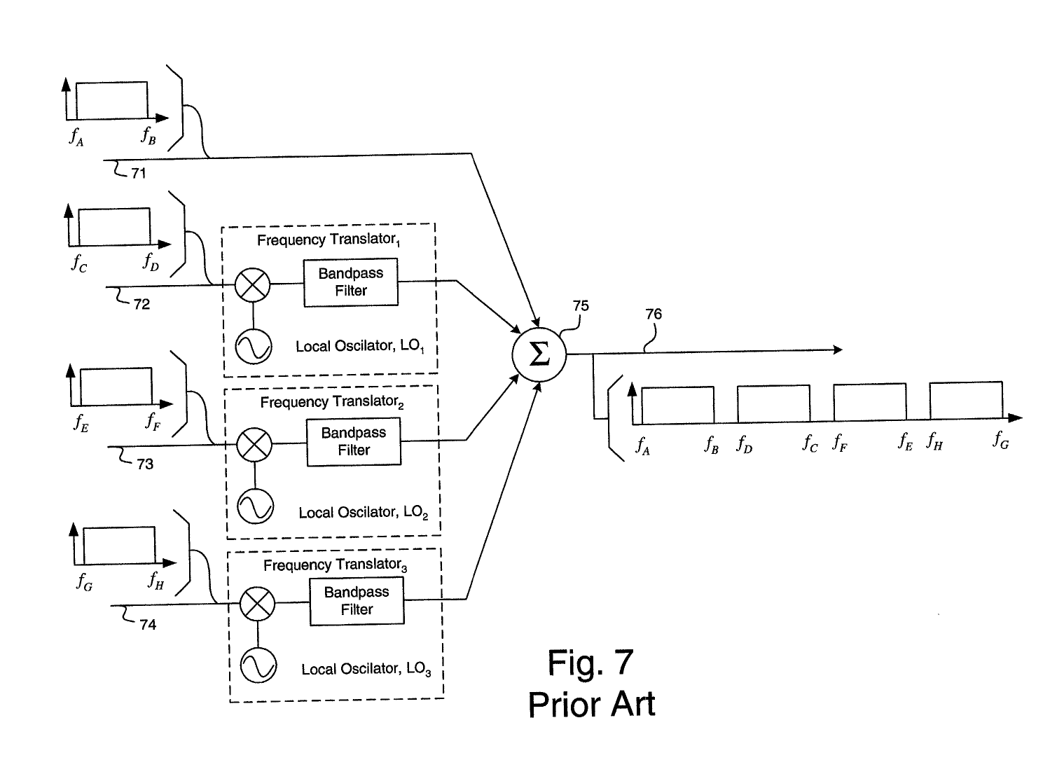

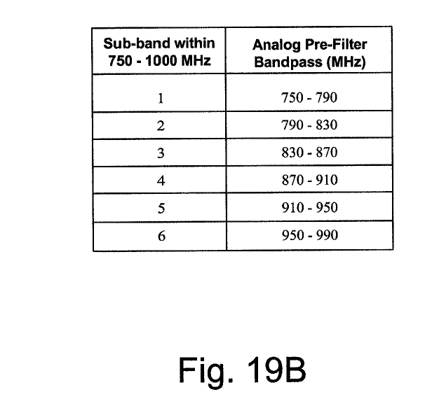

FIG. 19A and FIG. 19B show an illustrative embodiment of the present invention as applied to receiving upstream channels in the 750-1000 MHz portion of the spectrum plan illustrated by FIG. 3A and FIG. 3B. In the same manner as in FIG. 8, preceding the input to the pre-filters of FIG. 19A, one or more frequency stackers would be employed to insure that each sub-band of the 750-1000 MHz is densely packed. Those skilled in the art will understand that FIG. 19A is employing downsampling techniques to frequency translate down the high upstream band signals. The particular frequency of the sampling clock for each ADC is thus chosen as required to relocate each sub-band for subsequent processing by the programmable demodulators.

### Conclusion

Although the present invention has been described using particular illustrative embodiments, it will be understood that many variations in construction, arrangement and use are possible consistent with the teachings and within the scope of the invention. For example, interconnect and function-unit bit-widths, clock speeds, and the type of technology used may generally be varied in each component block of the invention. Also, unless specifically stated to the contrary, the value ranges specified, the maximum and minimum values used, or other particular specifications (such as those called for by the DOCSIS standard), are merely those of the illustrative or preferred embodiments, can be expected to track improvements and changes in implementation technology, and should not be construed as limitations of the invention. Functionally equivalent techniques known to those skilled in the art may be employed instead of those illustrated to implement various components or sub-systems. It is also understood that many design functional aspects may be carried out in either hardware (i.e., generally dedicated circuitry) or software (i.e., via some manner of programmed controller or processor), as a function of implementation dependent design constraints and the technology trends of faster processing (which facilitates migration of functions previously in hardware into software) and higher integration density (which facilitates migration of functions previously in software into hardware).

Specific variations within the scope of the invention include, but are not limited to: the particular number of downstream and upstream connectors, the particular digital filter architecture used, the particular synthesis algorithms used to design the filter response, and the number of coefficients used in the digital filters.

All such variations in design comprise insubstantial changes over the teachings conveyed by the illustrative embodiments. The names given to interconnect and logic are illustrative, and should not be construed as limiting the invention. It is also understood that the invention has broad applicability to other channel bank applications, and is not limited to the particular application or industry of the illustrated embodiments. The present invention is thus to be construed as including all possible modifications and variations encompassed within the scope of the appended claims.

We claim:

1. A method of demodulating multiple channels, comprising:
a) providing a first analog to digital converter having an analog input and a digital output;
b) providing a first plurality of digital demodulators, each demodulator having a programmable center frequency;
c) coupling a band of frequencies to the analog input of the converter, the band including a second plurality of channels;
d) creating digitized samples of the band at the output of the first converter;
e) coupling the digitized samples to the plurality of demodulators; and
f) demodulating a first plurality of channels from the band of frequencies.

2. The method of claim one, further including:
a) maintaining pre-computed sets of D.C. filter coefficients in non-volatile storage, each set corresponding to one of multiple prototype low-pass digital filters, each prototype filter having one of a predetermined set of bandwidths;
b) selecting a first center frequency and first bandpass bandwidth for provisioning a first one of the first plurality of demodulators;
c) retrieving the D.C. coefficients associated with the first bandwidth;
d) subjecting the retrieved D.C. coefficients to a band-pass transformation corresponding to the first center frequency;
e) loading the transformed coefficients into coefficient latches in the first demodulator.

3. The method of claim 3, further including:
a) operating the first demodulator at the first desired center frequency;
b) subsequent to said operating, loading the coefficient latches in the first demodulator with transformed coefficients corresponding to a second desired center frequency; and
c) operating the first demodulator at the second desired center frequency.

4. The method of claim 3, further including:
a) selecting a second center frequency and second bandpass bandwidth for provisioning a second one of the first plurality of demodulators, wherein said first and second bandbass bandwidths are unequal;
b) retrieving the D.C. coefficients associated with the second bandwidth;
c) subjecting the retrieved D.C. coefficients to a band-pass transformation corresponding to the second center frequency; and
d) loading the transformed coefficients into coefficient latches in the second demodulator.

5. The method of claim 1, wherein the converter and the demodulators are within the upstream section of a CMTS channel bank organized into upstream and downstream channels.

6. The method of claim 5, wherein the ratio of the number of upstream channels demodulated by the CMTS channel bank to the number of upstream input connectors of the CMTS channel bank is M.

7. The method of claim 6, wherein M is 16.

8. The method of claim 2, wherein the converter, the demodulators, and the non-volatile storage, are implemented on a single integrated circuit.

9. The method of claim 5, wherein the CMTS channel bank is organized using a plurality of modules, each module having a third plurality of downstream channels and and fourth plurality of upstream channels.

10. The method of claim 9, wherein the third plurality is 4 and the fourth plurality is 16.

11. The method of claim 9, wherein the channel bank has 8 modules.

12. The method of claim 5, wherein the CMTS channel bank has 32 downstream channels and 128 upstream channels.

13. The method of claim 5, wherein the CMTS is DOCSIS compatible.

14. The method of claim 5, wherein the upstream channels are in the 750-1000 MHz portion of the spectrum.

15. The method of claim 14, wherein at least one frequency stacker is used to densely pack each sub-band of the 750-1000 MHz spectrum portion.

16. The method of claim 1, wherein each demodulator uses an FIR digital filter.

17. The method of claim 16, wherein each FIR filter is an Optimum Equiripple Linear-Phase filter.

18. The method of claim 14, wherein the filter coefficients are designed using a Chebyshev approximation.

19. The method of claim 18, wherein the Parks-McClellan Alternation theorem is used in the approximation.

20. The method of claim 19, wherein the coefficients are computed using the Remez exchange algorithm.

21. The method of claim 19, wherein the coefficients are computed using the Rabiner exchange algorithm.

22. The method of claim 2, wherein the number of coefficients for each filter is at least 16.

23. The method of claim 2, wherein the number of coefficients for each filter is at most 24.
